(19) United States
(12) Patent Application Publication
(10) Pub. No.: US 2004/0175538 A1
(43) Pub. Date: Sep. 9, 2004

(54) Built-in structural form or piece of furniture

(76) Inventor: Reuben Star buck Jackson, Brooklyn, NY (US)

Correspondence Address: Reuben S. Jackson, 226 Broadway #3, Brooklyn, NY, 11211, US

(21) Appl. No.: 10/376,301

(22) Filed: Mar. 3, 2003

(51) Int. Cl. B32B 5/00

(52) U.S. Cl. 428/101

(57) ABSTRACT

A built-in structural form or piece of furniture constructed by compressing a plurality of structural members with a tensioning arrangement. The tensioning arrangement employs at least one tensioning element. The cross sectional area of the form, the compression resistance of the structural members, and the strength of the tensioning elements act together to make the article resistant to bending. The shapes of the individual structural members create the overall shape of the form both laterally from and axially along the tensioning elements. The forms of the invention are highly variable in performance and appearance and are easily assembled from efficiently made parts.

### FIELD OF THE INVENTION

The present invention relates to structural articles. More particularly, the present invention relates to the construction techniques for furniture and built-in structural elements.

### BACKGROUND

Design of physical forms is challenging for a number of reasons: their mass, functional voids, and surfaces must be appealing, strong, and scaled well to the human body. Tastes, environments, and human bodies are different.

Traditional lamination used to create the curved forms usually desired for furniture requires a mold and glue to fix the layers together. Substantial work goes into the bending and securing of the material. The nature of the process leads to repetition, as making customized molds is costly. Furthermore, the nature of traditional lamination requires that the material being laminated have some tensile strength. In the case of wood, the grain must be long and uninterrupted for tensile strength in a particular direction, which is ecologically expensive. With cast forms, there is the same necessity of the mold, which impedes the modification of different units.

### SUMMARY

A large, strong, durable, non-toxic, and beautiful structural article can be formed using a plurality of structural members in combination with a tensioning arrangement.

The structural article can be specialized to fit nearly any use. This construction can be useful at various scales, from small detailed pieces to larger building-sized structures. The invention at the scale of furniture is described herein.

The structural article resists vertical and lateral load. It translates bending stress by pulling the tension element (string), and compressing the structural members. (beads). Tightening the string strengthens the article. Because the beads are compressed and need not be tensile themselves, the material from which they are made can be almost anything—wood, plastic, rubber, metal, cork, rock, gel. “Recycled” materials that are not large enough to be reused in other ways can be used as beads. Patterns and choice of bead construction add customized visual, tactile, and performance characteristics. Furthermore, the shapes of the individual beads can be easily varied, affording detailed variation of design within the parameters of the invention.

### BRIEF DESCRIPTION OF THE DRAWINGS

FIG. 1 shows eight structural members (beads) and a tension element (string) connecting the structural members.

FIG. 2 is an exploded side elevation of an armchair embodying the invention.

FIG. 3 is an axonometric view of the armchair shown in FIG. 2.

FIG. 4 is an axonometric view of a table, which embodies the invention.

FIG. 5 is a partial exploded axonometric view of interlocking structural members of various shapes.

FIG. 6 is a detailed section through a construction containing the pieces shown in FIG. 5, with additional pieces.

FIG. 7 is a detailed section through a construction containing similarly-shaped pieces as FIG. 6, with an alternative overall shape and tensioning arrangement.

FIG. 8 is an axonometric view of a chair according to the invention, employing a tensioning arrangement involving two sets of overlapping tension elements.

FIG. 9 is a side elevation of the chair shown in FIG. 8.

FIG. 10 is an exploded side elevation of the chair shown in FIGS. 8 and 9.

### DETAILED DESCRIPTION

The drawings that are referred to here in closer detail, are examples of the invention and represent exemplary methods for embodying the invention at the present time. Further development of the invention and the associated constructive technology will result in substantial design improvements.

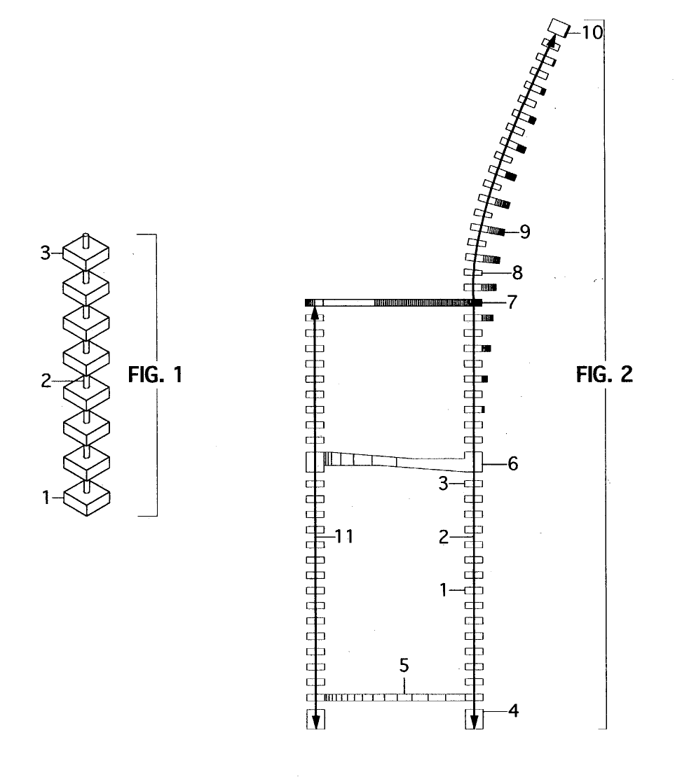

FIG. 1 shows a simple arrangement of similar beads (of which 1 and 3 are the end beads) and a tension element 2. The tension element, string 2, is tightened and fixed to end beads 1 and 3 to comprise an autonomous structural unit.

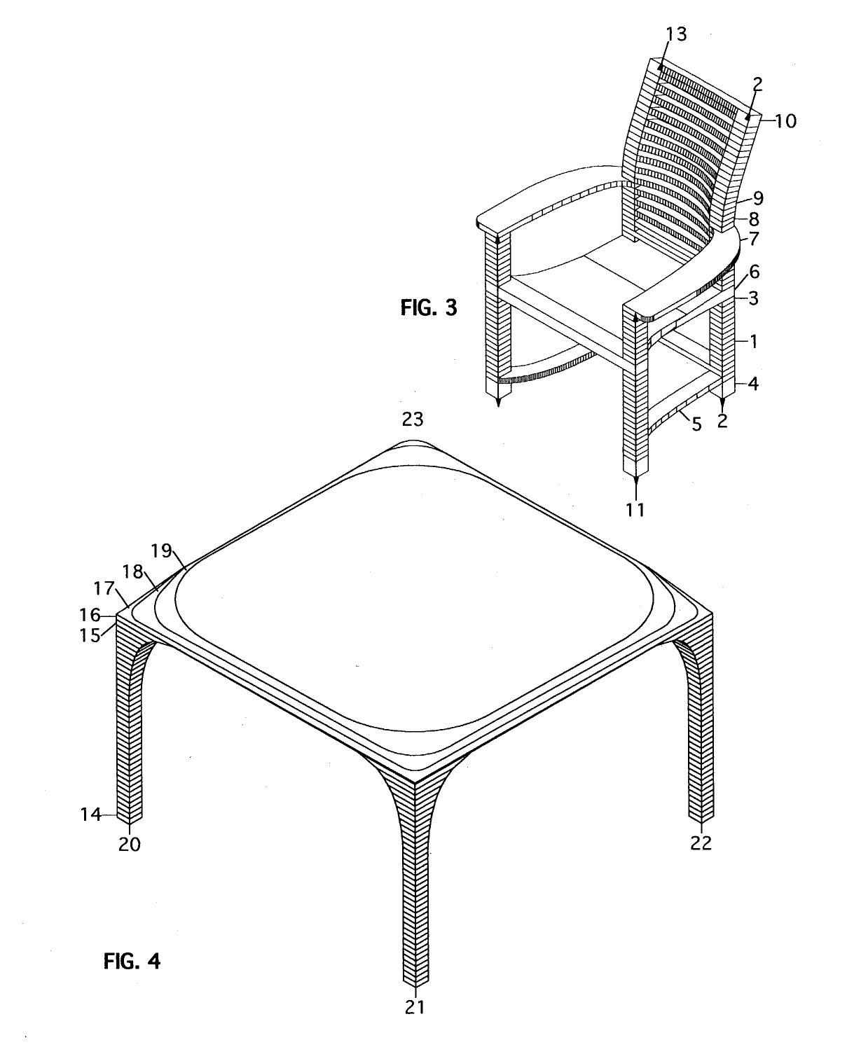

FIG. 2 shows FIG. 1 in context, as part of a chair leg. Here, string 2 runs from the bottom of the leg, bead 4, through left-side leg brace bead, 5, through beads like 1 and 3, through a seat bead, 6, through an armrest bead, 7, through wedge beads like 8, through backrest beads like 9, to head bead, 10. Wedge beads do not have a uniform thickness and therefore create an inflection in the form. Wedges are used to make curves that bend the string. The left-side leg brace bead, 5, seat bead, 6, armrest bead, 7, and backrest bead, 9 are all acted upon by multiple strings and will be better understood in FIG. 3.

FIG. 3 shows an axonometric view of the whole chair. Note locations of pieces 1-10, and additionally, strings 11, 12, and 13. String 11 compresses left-side leg brace bead, 5, and seat bead, 6, and connects to armrest bead, 7. String 12 mirrors string 11 on the right side. String 13 mirrors string 2, compressing a multitude of beads like 1 and 3, a leg brace bead, like 5, seat bead, 6, an armrest bead, like 7, a multitude of backrest beads like 9 and wedge beads like 8, and connects to head bead, 10. The seat member, as all beads, is strong enough to translate its load to the adjacent structural members. Long pieces connect the rear two strings, regularly alternating with smaller members, to form the backrest. The backrest beads are shaped differently to create an ergonomic shape.

FIG. 4 shows a table constructed according to the invention. The top is a specialized piece, composed of pieces 16-19. 15 is the active bead that connects to tension element 20. Bottom bead 14 attaches to tension element 20, which is concealed within the structural members of the leg. The beads located between beads 14 and 15 are compressed when tension element 20 is tightened. There are no wedges in this construction—the structural members comprising the legs are of a uniform thickness.

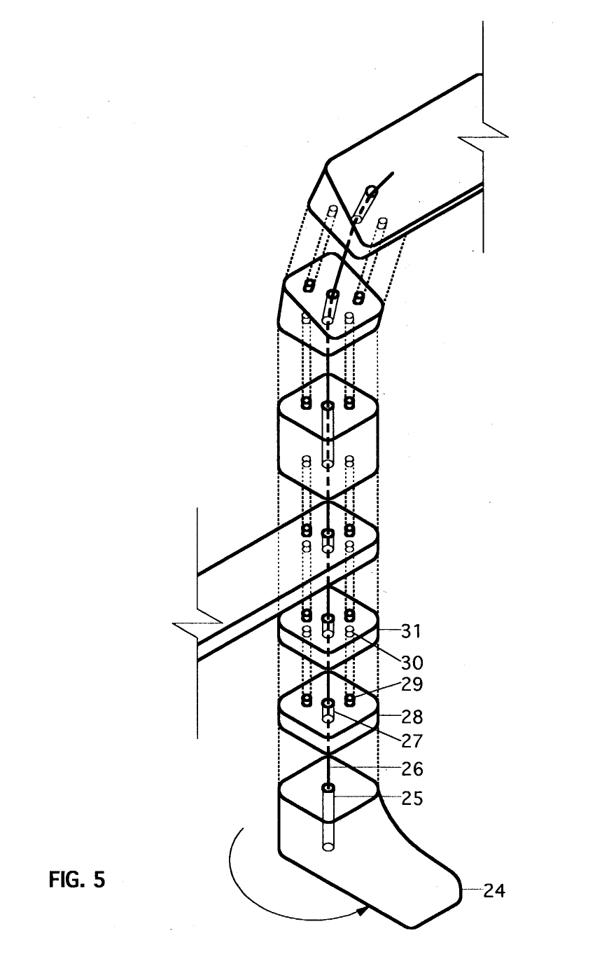

FIG. 5 shows a detail of an interlocking arrangement. Without the tensile string, the form composed by the assembled beads would not adequately resist bending. The tension in the string compresses the beads together, keeping them interlocked and structurally unified. Bottom bead 24 attaches to string 26, through hole 25, which corresponds to hole 27 on piece 28. Male connectors like 29 on piece 28 interlock with female openings like 30 on piece 31. The male-female interlocking arrangement formed by connectors like 29 and 30 is a simple technology for interlocking the beads. Glue can be used instead, but this is not ideal because the connection must allow for slight deflections, which can cause failure in the glue bond. Without the string, the form created by interlocking beads is not tensile.

FIG. 6 shows a detailed section through an assembly containing the pieces shown in exploded form in FIG. 5. Bottom bead, 24, does not interlock with bead 28. Bottom bead, 24, is a tightening bead that connects to string 26, via an embedded tea-nut 32. String 26 is a steel rod with a threaded section that allows the tightening of the arrangement by rotating bottom bead 24, pulling string 26 through hole 25. Piece 34 is a base which creates a suitably stable connection to the floor. It is a special piece—it serves a specific function. The extra string, 26, that passes through hole 25 in bottom bead, 24, passes into recess 33, on piece 34. Connector 35 (screw, dowel, glue etc.) unites bead 24 with special piece, 34, to form a special bead. Armrest bead, 7, and head bead, 10 in FIGS. 2 and 3 are special beads. The tabletop in FIG. 4 is a special bead. The special base bead shown here has the connector 35 entering from the special piece 34, but other special beads can have the connectors exposed on either the active bead or the special piece, depending on function or design.

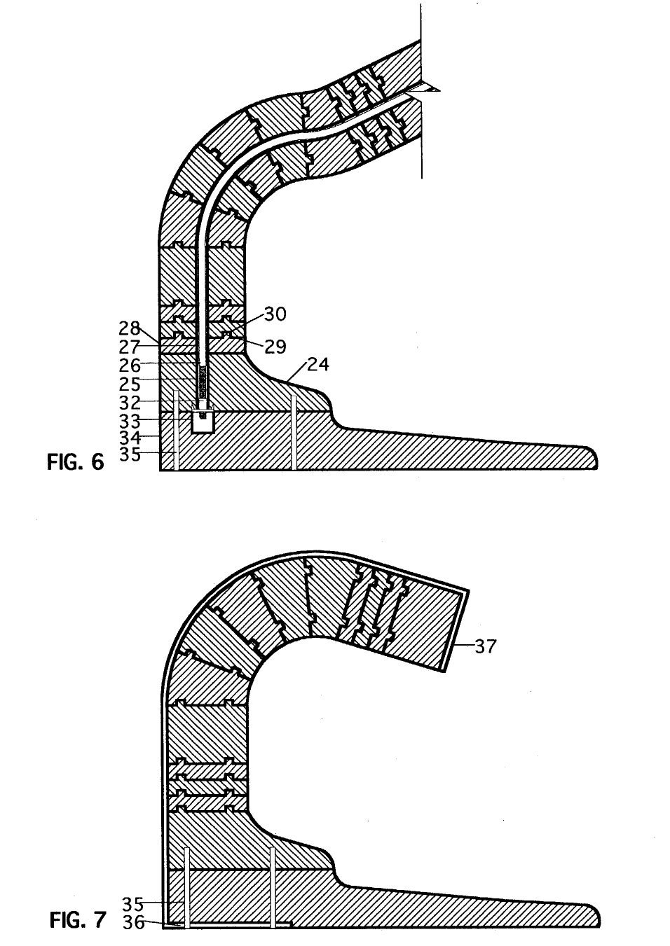

FIG. 7 shows an alternate type of tensioning arrangement. String 26 is on the surface of the assembled form. It is fixed at both ends to the compression beads. String 26 uses anchors 36 and 37 to fix its ends to the compression beads. These anchors can involve integral returns, or connectors that serve to embed the string in the end beads, with a tension resistant connection formed between the bead and the string. The string only resists applied load, and none of the mechanical tightening described in FIGS. 5 and 6 is required. Since the string is on the surface, the form only resists bending in one direction. The greater the size of the compression-bearing area, the better the resistance to bending.

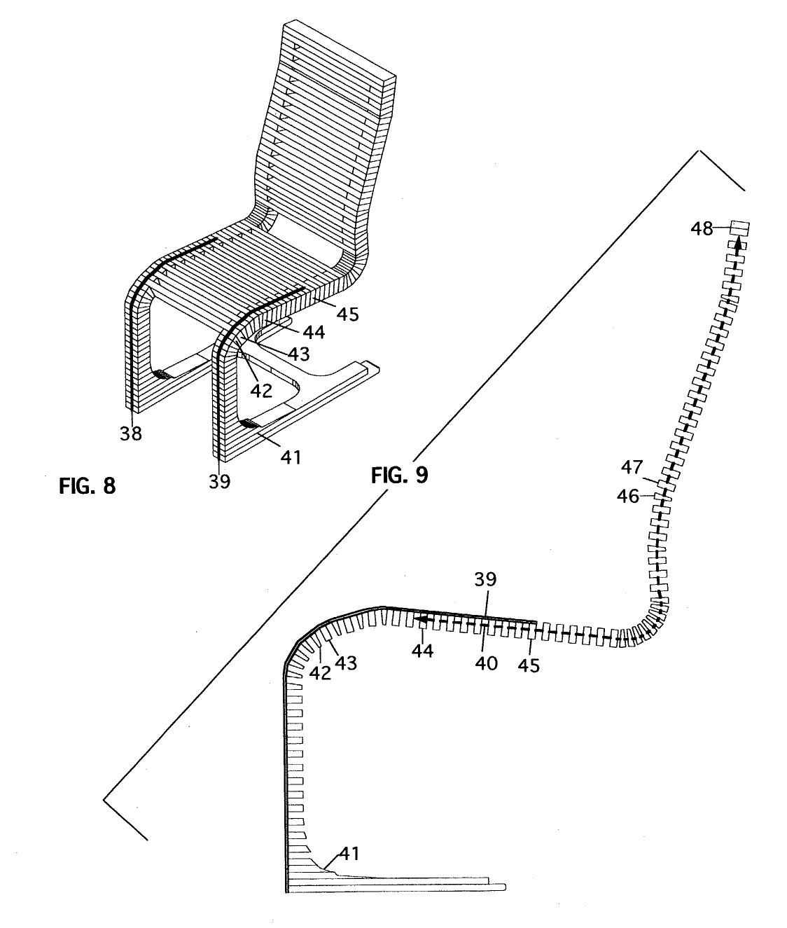

FIGS. 8 and 9 show a chair comprised of beads on strings. FIG. 8 shows an axonometric view of the chair. FIG. 9 shows an exploded side elevation of the chair. There is a variety of differently shaped structural members. There are exposed tension elements 38 and 39. Focusing on the left side of the chair, tension elements 39 and 40 overlap. Structural seat beads from bead 44 to bead 45 are being compressed by both, tension element 39, on the outside, and 40 on the inside. Special base bead, 41, is connected to all the other beads, up to seat bead, 45 by exposed tension member 39. Dividing the tensioning length and using a tension element on the surface, adds flexibility of design, strength and adjustability. Wedge bead, 42, helps form the curve at the knee of the chair. Bead 43 is the bottom most seat bead that is part of and is compressed by strings 38 and 39. On the backrest, wedge bead, 46 helps create an ergonomic shape. Bead 47 connects to tension element 40 as well as the right side equivalent. Bead 48 is the head bead.

Each figure illustrates how beads on a string can be tightened to form pieces of furniture. When the bead is required to span a distance without support, the material composing the bead must be strong enough to resist loads and transfer those loads into the adjacent beads and into the tensioning arrangement. When there are specific design requirements, the beads are shaped and composed in a way that satisfies those needs—the beads can be complex composites. The illustrated furniture articles illustrated present a diversity of structural relationships.

The materials used can vary with design and function. The beads can be wood, plastic, rubber, metal, cork, rock, inflated, gel or composites.

The stacked nature of the article lends to the easy creation of patterns, compositional customization, and diversification. Oriented material, like wood, can be alternated at ninety degrees to contrast the different textures of the grain. Different materials, with different qualities, including color, transparency, weight, sound dynamic properties, tactile properties, and compressive resistance can be used.

The stacked nature of the article lends to the easy customization of its shape. The shapes of the many pieces comprising the article can be varied very easily, and can be efficiently generated. Standardization of beads can occur, while the combinations of standard parts can yield highly varied products.

The tension arrangement can involve metal (rods, bars, cables), ropes (hemp, nylon, Kevlar), wood dowels, plastic bars, or rubber bands. The connection between the tensioning element and the end beads can be made with a static connection, or involve a dynamic, adjustable connection. The tensioning elements can be vertical, horizontal, diagonal, and curvy.

The scale and autonomy of the invention is variable. A wall to a house, composed of beads, can have integral, cantilevered shelf and table beads, window beads, sandwiched together between floor and ceiling beads. The material and shape of the wall beads describe the structural, transmissive (light, heat, air, water), and decorative specificity. The invention unifies and integrates a diversity of materials into a multifunctional unit that is durable and variable.

Stringing together a number of small beads creates long beams or columns. Beam-column composite structures are easily formed with this invention.

Because of its challenging design requirements, furniture provides a good microcosm in which to experiment with the invention. Furniture has many of the same requirements as buildings, although in miniature, and it is apparent that the present invention is useful at larger scales.

What is claimed is:

1. A structural article, comprising:
a. a plurality of at least 3 structural members; and
b. a tensioning arrangement connecting and compressing the plurality of structural members.

2. An article according to claim 1, wherein the article is one of an piece of furniture and a built-in structural element.

3. An article according to claim 1, wherein the tensioning arrangement compresses the middle structural members between the end members.

4. An article according to claim 1, wherein:
a. the plurality of structural members comprises compression-resistant material; and
b. the tensioning arrangement comprises at least one tension element.

5. An article according to claim 4, wherein the at least one tension element is stressed before a load is applied to the article.

6. An article according to claim 4, wherein the at least one tension element is stressed as a reaction to an applied load.

7. An article according to claim 4, wherein the plurality of structural members further comprises a non-tensile form.

8. An article according to claim 7, wherein the plurality of structural members comprises a plurality of interlocking pieces.

9. An article according to claim 4, wherein the plurality of structural members includes a structural member that is compressed by a plurality of tension elements.

10. An article according to claim 4, wherein one of the structural members includes an active bead, which is adapted to secure to the at least one tension element.

11. An article according to claim 10, further comprising an adjustable connection, adapted to secure the active bead to the at least one tension element.

12. An article according to claim 9, wherein the adjustable connection comprises a threaded connection.

13. An article according to claim 9, wherein the adjustable connection comprises a locking mechanism.

14. An article according to claim 8, wherein the active bead further includes a specialized piece, the specialized piece being one of a table top, an armrest, a seat, a base, a foot, a shelf, a leg and a headrest.

16. An article according to claim 4, wherein the at least one tension element passes through the structural members.

17. An article according to claim 4, wherein the at least one tension element is exposed.

18. An article according to claim 4, wherein the at least one tension element comprises metal.

19. An article according to claim 4, wherein the plurality of structural members have a variable thickness.

20. An article according to claim 4, wherein the plurality of structural members comprises wood.
